(19) United States
(12) Patent Application Publication
(10) Pub. No.: US 2026/0131825 A1
(43) Pub. Date: May 14, 2026

(54) CONTROL DEVICE

(71) Applicant: TOYOTA JIDOSHA KABUSHIKI KAISHA, Toyota-shi (JP)

(72) Inventors: Shimpei ISOBE, Toyota-shi (JP); Hiroaki NISHINO, Toyota-shi (JP); Hironaga ONO, Toyota-shi (JP); Manabu HANDA, Toyota-shi (JP); Yohei ONO, Nisshin-shi (JP); Ritsu NISHIMURA, Nagoya-shi (JP); Manabu HIROSE, Okazaki-shi (JP); Ryohei CHINO, Nisshin-shi (JP)

(73) Assignee: TOYOTA JIDOSHA KABUSHIKI KAISHA, Toyota-shi (JP)

(21) Appl. No.: 19/351,379

(22) Filed: Oct. 7, 2025

(30) Foreign Application Priority Data
Nov. 8, 2024 (JP) 2024-196044

(51) Int. Cl. B60W 60/00

(52) U.S. Cl. CPC B60W 60/0011; B60W 60/0016; B60W 60/00256; B60W 2554/4049; B60W 2720/24

(57) ABSTRACT

A control device includes a processor configured to: calculate a device travel path for a vehicle transport device at a time of changing a parking position of a vehicle within a parking lot, the vehicle transport device being configured to transport the vehicle by driving autonomously; calculate a vehicle travel path for a manually driven vehicle to travel from a parking lot entrance to a designated parking position when the manually driven vehicle enters the parking lot; determine whether there is a collision risk between the manually driven vehicle and the vehicle transport device when the manually driven vehicle deviates from the vehicle travel path; and change the device travel path when it is determined there exists the collision risk.

The present application claims priority to and incorporates by reference the entire contents of Japanese Patent Application No. 2024-196044 filed in Japan on Nov. 8, 2024.

### BACKGROUND

The present disclosure relates to a control device.

JP 2023-9063 A discloses a vehicle transport system capable of efficiently operating charging spaces provided at charging spots. In this technology, after a vehicle is stopped in a parking space, a transport robot transports the vehicle from the parking space to a parking spot.

### SUMMARY

If a driver can manually park a vehicle directly into a parking space, the effort of having a transport robot move the vehicle from the parking space to the parking area can be eliminated. In this case, since manual driving by the driver and automatic operation of the vehicle transport device coexist within the parking lot, it is necessary to operate the vehicle transport device in a manner that ensures safety.

There is a need for a control device that enables the vehicle transport device to travel safely within a parking lot where manual driving by the driver and automatic driving by the vehicle transport device coexist.

According to one aspect of the present disclosure, there is provided a control device including a processor configured to: calculate a device travel path for a vehicle transport device at a time of changing a parking position of a vehicle within a parking lot, the vehicle transport device being configured to transport the vehicle by driving autonomously; calculate a vehicle travel path for a manually driven vehicle to travel from a parking lot entrance to a designated parking position when the manually driven vehicle enters the parking lot; determine whether there is a collision risk between the manually driven vehicle and the vehicle transport device when the manually driven vehicle deviates from the vehicle travel path; and change the device travel path when it is determined there exists the collision risk.

### BRIEF DESCRIPTION OF THE DRAWINGS

FIG. 1 is a block diagram illustrating a configuration of a charging management system including a control device;

FIG. 2 is a diagram illustrating a schematic configuration of a parking lot equipped with charging spots managed by the control device;

FIG. 3 is a flowchart illustrating processing performed by the control device;

FIG. 4 is a diagram illustrating an example of data managed by a parking management server; and

FIG. 5 is a diagram showing an example of data managed by a charging management server.

### DETAILED DESCRIPTION

A control device according to an embodiment of the present disclosure will be described with reference to the drawings. Note that the components in the following embodiments include those that are replaceable and readily available to those skilled in the art, or those that are substantially identical.

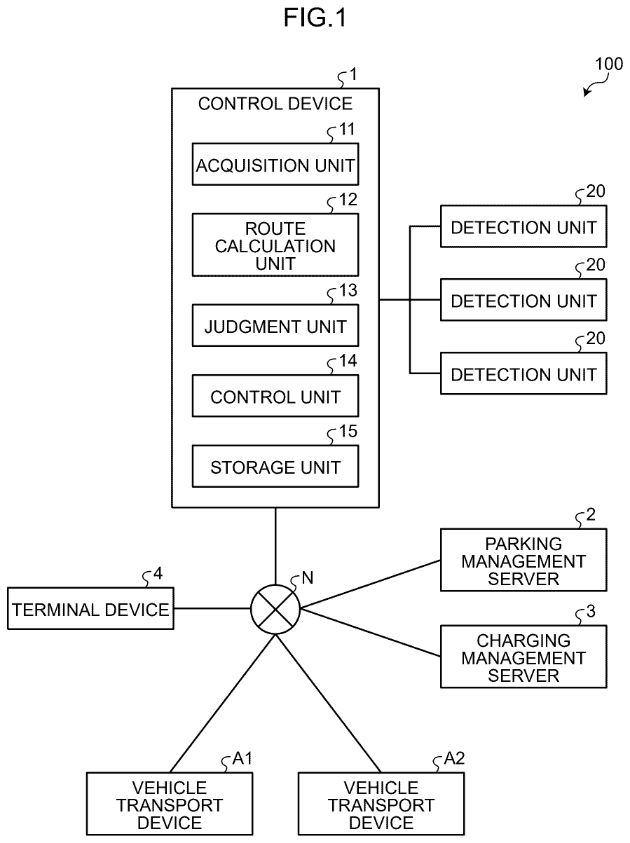

FIG. 1 is a block diagram illustrating a configuration of a charging management system including the control device. As illustrated in FIG. 1, the charging management system 100 includes a control device 1, a parking management server 2, a charging management server 3, a terminal device 4, a vehicle transport device A1, and a vehicle transport device A2. The control device 1, parking management server 2, charging management server 3, terminal device 4, vehicle transport device A1, and vehicle transport device A2 are each equipped with communication functions and are configured to communicate with each other via network N and exchange various information. This network N is formed, for example, by a public line network such as an Internet line network or a mobile phone line network.

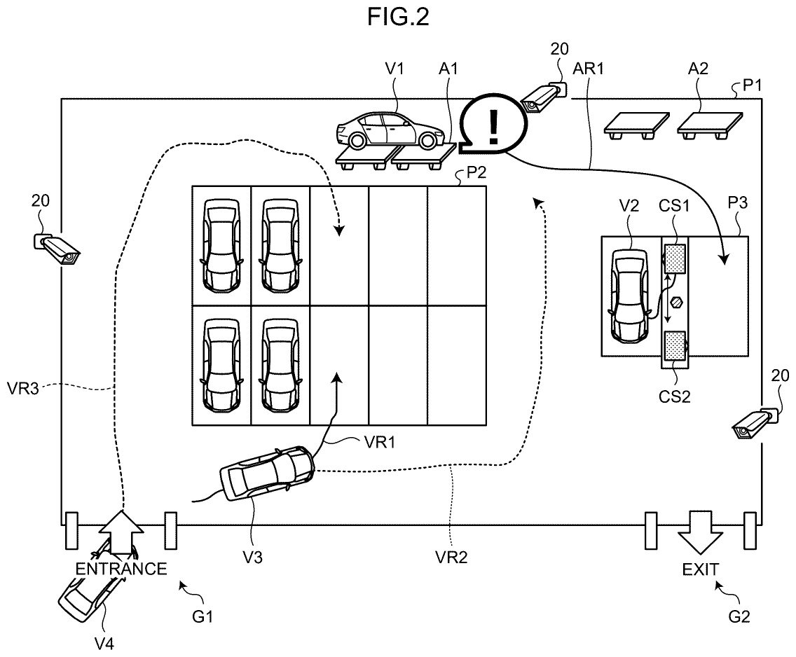

FIG. 2 is a schematic diagram illustrating the general configuration of a parking lot equipped with charging spots managed by the control device. As illustrated in FIG. 2, the parking lot P1 managed by the control device 1 includes parking spaces P2, which are spaces for parking vehicles, and charging spaces P3, where vehicles can be charged via charging spots CS1 or CS2.

The vehicle transport devices A1 and A2 transport vehicles by driving autonomously along a device travel path transmitted by the control device 1. The vehicle transport devices A1 and A2 may, for example, include two devices that lift and transport the front and rear wheels of a vehicle, respectively; however, their configuration is not particularly limited. Furthermore, the number of vehicle transport devices is not limited to two; it may be one device or three or more devices.

An entrance gate G1 is provided at the entrance of parking lot P1, for example, using a gate bar or the like, to restrict vehicle entry into parking lot P1. An exit gate G2 is provided at the exit of parking lot P1, for example, using a gate bar or the like, to restrict vehicle exit from parking lot P1. Entrance gate G1 and exit gate G2 manage vehicle entry and exit to/from parking lot P1 under control of the control device 1.

Furthermore, multiple detection units 20 are positioned within parking lot P1. Detection units 20, such as cameras or LIDAR (Laser Imaging Detection and Ranging), detect the positions of vehicles within parking lot P1.

Vehicles V1 to V4 are manually driven vehicles capable of manual operation by a driver, but may also include autonomous vehicles. Furthermore, vehicles V1 to V4 are electric vehicles equipped with batteries that can be charged by charging spots CS1 or CS2.

The control device 1 charges vehicles parked in parking lot P1 by moving them from parking space P2 to charging space P3 using vehicle transport devices A1 and A2. Furthermore, the control device 1 moves vehicles whose charging has completed from charging space P3 back to parking space P2 using vehicle transport devices A1 and A2. As a result, the control device 1 can efficiently charge vehicles in the parking lot P1 equipped with charging spots CS1 and CS2.

The control device 1 includes a processor, for example including a central processing unit (CPU), and a memory (main storage unit) including a random-access memory (RAM) and a read-only memory (ROM), etc.

The control device 1, as illustrated in FIG. 1, includes an acquisition unit 11, a route calculation unit 12, a determination unit 13, a control unit 14, and a storage unit 15.

The acquisition unit 11 acquires parking management data from the parking management server 2. The acquisition unit 11 also acquires charging management data from the charging management server 3. Furthermore, the acquisition unit 11 acquires various data from the detection unit 20.

The route calculation unit 12 calculates the travel routes for the vehicle transport devices A1 and A2 when changing the parking positions of vehicles within the parking lot P1. Specifically, the route calculation unit 12 calculates the device travel route when the vehicle transport devices A1 and A2 move a vehicle from parking space P2 to charging space P3, or when the vehicle transport devices A1 and A2 move a vehicle from charging space P3 to parking space P2.

Furthermore, the path calculation unit 12 calculates the vehicle travel path for a manually driven vehicle traveling from the entrance of parking lot P1 to its designated parking position when such a vehicle enters parking lot P1. Additionally, the path calculation unit 12 changes the travel path of a vehicle transport device deemed to have a collision risk by the determination unit 13. Specifically, the path calculation unit 12 changes the device travel path of the vehicle transport device by pausing the vehicle transport device, temporarily retracting the vehicle transport device, or recalculating the device travel path of the vehicle transport device. At this time, it is preferable for the path calculation unit 12 to change the device travel path of the vehicle transport device such that the operation of this vehicle transport device is minimized.

The determination unit 13 determines whether there is a collision risk between the manually operated vehicle and the vehicle transport devices A1 and A2 when the manually operated vehicle deviates from its travel path. Specifically, the determination unit 13 determines whether a collision risk exists based on the distance between the deviated manually operated vehicle and the vehicle transport device, the direction of travel of the deviated manually operated vehicle and the vehicle transport device, and the speed of the deviated manually operated vehicle and the vehicle transport device.

The control unit 14 controls the entire control device 1.

The storage unit 15 stores the parking management data and charging management data acquired by the acquisition unit 11. The storage unit 15 also stores the device travel route and vehicle travel route calculated by the route calculation unit 12. The storage unit 15 is implemented using components such as ROM, RAM, solid state drive (SSD) and hard disk drive (HDD).

The parking management server 2 is a server that manages vehicles entering and exiting parking lot P1.

The charging management server 3 is a server that manages vehicles charging at charging spots CS1 and CS2.

The terminal device 4 is a terminal such as a smartphone held by the driver of a manually driven vehicle. The terminal device 4 outputs information such as the scheduled entry time to parking lot P1, desired exit time, and desired charging amount to the parking management server 2 in response to the driver's operational input.

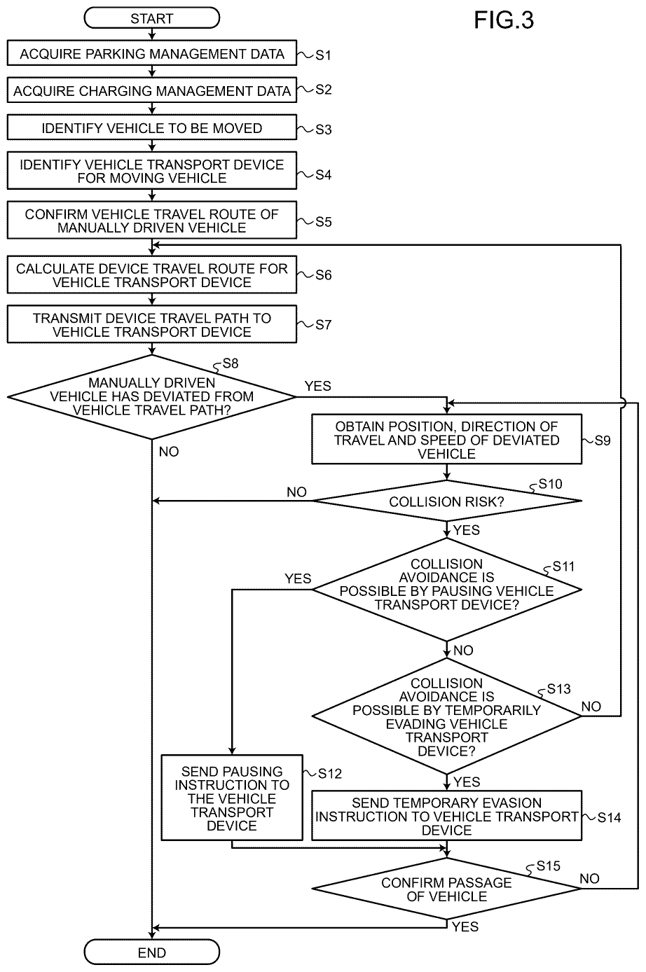

Next, the control method performed by the control device 1 is described. FIG. 3 is a flowchart illustrating the processing executed by the control device.

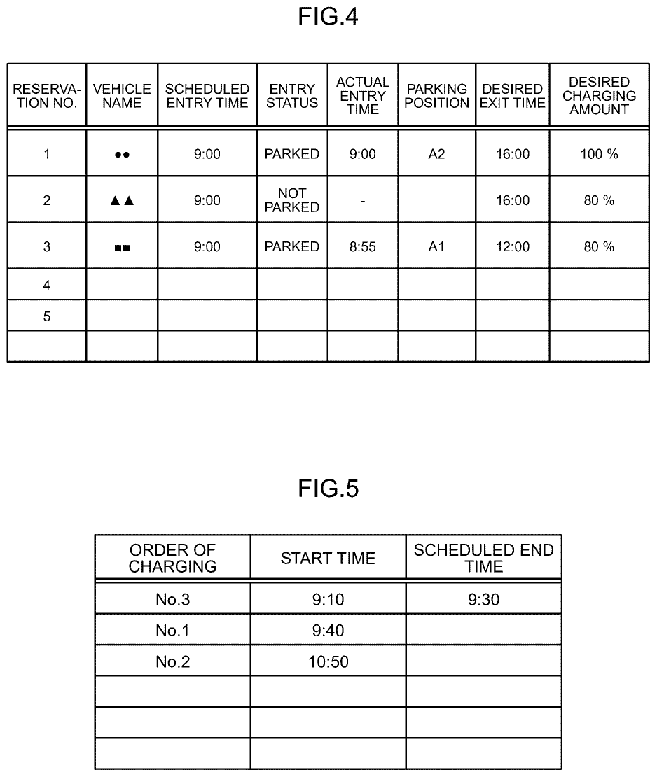

As illustrated in FIG. 3, the acquisition unit 11 acquires parking management data from the parking management server 2 (Step S1). FIG. 4 is a diagram illustrating an example of data managed by the parking management server. As illustrated in FIG. 4, the parking management server 2 manages vehicle entry into the parking lot P1 by managing data such as the reservation number, the name of the reserved vehicle, the scheduled entry time set at the time of reservation, the current entry status, the actual entry time when the vehicle entered, the parking position in parking space P2, the desired exit time set at the time of reservation, and the desired charging amount set at the time of reservation. The acquisition unit 11 acquires parking management data from the data managed by the parking management server 2, including at least the scheduled entry time and the parking position.

Based on the parking management data, the control device 1 opens the entrance gate G1 and permits the vehicle to enter parking lot P1 when the vehicle corresponding to the reservation arrives at entrance gate G1 within a predetermined time before or after the scheduled entry time. The control device 1 then calculates the vehicle travel route from the entrance gate G1 of parking lot P1 to the designated parking position (the parking position in the parking management data).

Furthermore, the acquisition unit 11 acquires charging management data from the charging management server 3 (Step S2). FIG. 5 is an example diagram showing data managed by the charging management server. As illustrated in FIG. 5, the charging management server 3 manages charging at charging spots CS1 and CS2 by managing data such as the charging sequence (indicating the order of charging), the start time for charging, and the scheduled end time for charging. The acquisition unit 11 then acquires charging management data from the data managed by the charging management server 3, including at least the start time and the scheduled end time for charging.

Next, the route calculation unit 12 identifies vehicles moving from parking space P2 to charging space P3, or vehicles moving from charging space P3 to parking space P2, based on the parking management data and charging management data (Step S3). Specifically, the route calculation unit 12 identifies the next vehicle to move based on the start time and scheduled end time in the charging management data.

Furthermore, the route calculation unit 12 identifies which vehicle transport device will move the identified vehicle (Step S4). The route calculation unit 12 determines whether the identified vehicle will be moved by vehicle transport device A1 or vehicle transport device A2 based on the operational status of vehicle transport devices A1 and A2.

Subsequently, the route calculation unit 12 confirms the vehicle travel route of the manually driven vehicle (Step S5).

Then, the route calculation unit 12 calculates the device travel route for the vehicle transport device moving the vehicle (Step S6).

Furthermore, the control device 1 transmits the device travel path of the vehicle transport device to that vehicle transport device (Step S7).

Through Steps S1 to S7 described above, each vehicle transport device travels along the device travel path transmitted by the control device 1. Additionally, each vehicle undergoing manual operation travels along the vehicle travel path indicated by the control device 1. The control device 1 indicates the vehicle travel path to each vehicle, for example, by projecting arrows representing the vehicle travel path onto the floor of parking lot P1 using projection lights installed on the ceiling of parking lot P1. Alternatively, the control device 1 may indicate the vehicle travel path to each vehicle using voice output from speakers installed in parking lot P1. The control device 1 may also indicate the vehicle travel path to each vehicle by transmitting the vehicle travel path to, for example, terminal device 4.

In the example of FIG. 2, when vehicle V3 enters parking lot P1, control device 1 calculates vehicle travel route VR1, which is the route vehicle V3 travels from the entrance of parking lot P1 to the designated parking position. Similarly, when vehicle V4 enters parking lot P1, control device 1 calculates vehicle travel route VR3, which is the route vehicle V4 travels from the entrance of parking lot P1 to the designated parking position. Furthermore, the control device 1 identifies the vehicle transport device moving vehicle V1 as vehicle transport device A1 and calculates device travel path AR1 for when vehicle transport device A1 moves vehicle V1 from parking space P2 to charging space P3. Vehicle V2 is being charged by charging spot CS1.

Returning to FIG. 3, the determination unit 13 determines whether the manually driven vehicle has deviated from the vehicle travel path (Step S8).

If the determination unit 13 determines that the manually driven vehicle has not deviated from the vehicle travel path (Step S8: No), the series of processes ends.

On the other hand, if the determination unit 13 determines that the vehicle in manual driving mode has deviated from the vehicle travel path (Step S8: Yes), the acquisition unit 11 acquires the data detected by the detection unit 20 and obtains the position, direction of travel, and speed of the deviated vehicle from this data (Step S9). Furthermore, if the determination unit 13 determines that the manually driven vehicle has deviated from the vehicle travel path, the control device 1 may notify the deviating vehicle of the deviation via an audio message or warning sound.

Then, the determination unit 13 determines whether there is a collision risk between the manually driven vehicle that has deviated from the vehicle travel path and the vehicle transport device (Step S10). Determination unit 13 determines whether a collision risk exists based on the distance between the vehicle and the vehicle transport device, the direction of travel of the vehicle and the vehicle transport device, and the speed of the vehicle and the vehicle transport device, using an algorithm stored in advance in storage unit 15.

If determination unit 13 determines that there is no collision risk (Step S10: No), the series of processes ends.

On the other hand, if the determination unit 13 determines that there is a collision risk (Step S10: Yes), the determination unit 13 determines whether collision avoidance is possible by pausing the vehicle transport device (Step S11).

If the determination unit 13 determines that collision can be avoided by pausing the vehicle transport device (Step S11: Yes), the path calculation unit 12 sends a pausing instruction to the vehicle transport device (Step S12).

On the other hand, if the determination unit 13 determines that collision avoidance is not possible by pausing the vehicle transport device (Step S11: No), the determination unit 13 determines whether collision avoidance is possible by temporarily evading the vehicle transport device (Step S13).

If the determination unit 13 determines that collision avoidance is possible by the vehicle transport device temporarily evading (Step S13: Yes), the path calculation unit 12 sends a temporary evasion instruction to the vehicle transport device (Step S14).

On the other hand, if the determination unit 13 determines that collision avoidance is impossible by temporarily moving the vehicle transport device (Step S13: No), the process returns to Step S6, and the route calculation unit 12 recalculates the device travel route for the vehicle transport device.

Subsequently, the determination unit 13 determines whether the passage of the vehicle has been confirmed (Step S15).

If the determination unit 13 determines that the passage of the vehicle has been confirmed (Step S15: Yes), the series of processes ends.

On the other hand, if the determination unit 13 determines that the vehicle's passage cannot be confirmed even after a predetermined time has elapsed (Step S15: No), it returns to Step S9, acquires the vehicle's position, direction of travel, and speed again, and determines the collision risk.

In the example of FIG. 2, the vehicle transport device A1 is moving vehicle V1 from parking space P2 to charging space P3 along device travel path AR1. At this time, vehicle V3 deviates from vehicle travel path VR1 and travels along vehicle travel path VR2. Consequently, determination unit 13 determines that manually driven vehicle V3 has deviated from vehicle travel path VR1. The determination unit 13 then determines whether there is a collision risk between vehicle V3 and vehicle transport device A1. If the determination unit 13 determines that a collision risk exists, the path calculation unit 12 changes the device travel path of vehicle transport device A1 by either pausing vehicle transport device A1, temporarily retracting vehicle transport device A1, or recalculating the device travel path of vehicle transport device A1.

According to the described embodiment, when a collision risk is determined, the vehicle transport device can be operated safely within a parking lot where manual operation by drivers and automatic operation of the vehicle transport device coexist, by changing the device travel path of the vehicle transport device.

In the embodiment, an example was described where the path calculation unit 12 changes the device travel path of the vehicle transport device to minimize the device's operation. When the determination unit 13 determines a collision risk exists, the path calculation unit 12 changes the device travel path of the vehicle transport device A1 in the following sequence: pausing the vehicle transport device, temporarily retreating the vehicle transport device, and recalculating the device travel path. As a result, the operation of the vehicle transport device is minimized.

Furthermore, the path calculation unit 12 may modify the device travel path of the vehicle transport device to minimize the time required for the vehicle transport device to complete vehicle transport. In this case, the path calculation unit 12 selects the operation from among pausing the vehicle transport device, temporarily retracting the vehicle transport device, and recalculating the device travel path that results in the shortest time until the vehicle transport device completes the vehicle transport.

According to the present disclosure, a control device can be realized that enables the vehicle transport device to travel safely within a parking lot where manual driving by an operator and automatic driving by the vehicle transport device coexist.

Further effects and variations can be readily derived by those skilled in the art. Therefore, the broader aspects of the present disclosure are not limited to the specific details and representative embodiments described and illustrated above. Consequently, various modifications are possible without departing from the spirit or scope of the general concept of the disclosure as defined by the appended claims and their equivalents.

What is claimed is:

1. A control device comprising a processor configured to:
calculate a device travel path for a vehicle transport device at a time of changing a parking position of a vehicle within a parking lot, the vehicle transport device being configured to transport the vehicle by driving autonomously;
calculate a vehicle travel path for a manually driven vehicle to travel from a parking lot entrance to a designated parking position when the manually driven vehicle enters the parking lot;
determine whether there is a collision risk between the manually driven vehicle and the vehicle transport device when the manually driven vehicle deviates from the vehicle travel path; and
change the device travel path when it is determined there exists the collision risk.

2. The control device according to claim 1, wherein the processor is configured to, when determining that the collision risk exists:
control the vehicle transport device to pause;
control the vehicle transport device to temporarily evade; or
recalculate the device travel path.

3. The control device according to claim 1, wherein the processor is configured to change the device travel path such that an operation of the vehicle transport device is minimized.

4. The control device according to claim 1, wherein the processor is configured to change the device travel path such that a duration for the vehicle transport device to complete transporting the vehicle is minimized.

5. The control device according to claim 1, wherein the processor is configured to determine whether the collision risk exists based on: a distance between the manually driven vehicle and the vehicle transport device; directions of travel of the manually driven vehicle and the vehicle transport device; and speeds of the manually driven vehicle and the vehicle transport device.
